(19) United States
(12) Patent Application Publication
(10) Pub. No.: US 2024/0040314 A1
(43) Pub. Date: Feb. 1, 2024

(54) VIBRATION AND AUDIO OUTPUT DEVICE AND ELECTRONIC EQUIPMENT

(71) Applicant: AAC Microtech (Changzhou) Co., Ltd., Changzhou (CN)

(72) Inventors: Ronglin Linghu, Changzhou (CN); Wei Song, Changzhou (CN); Xingzhi Huang, Changzhou (CN)

(21) Appl. No.: 18/334,343

(22) Filed: Jun. 13, 2023

Related U.S. Application Data
(63) Continuation of application No. PCT/CN2022/118460, filed on Sep. 13, 2022.

(30) Foreign Application Priority Data
Jul. 27, 2022 (CN) 202210892867.7

(51) Int. Cl. H04R 3/14; G10L 19/008

(52) U.S. Cl. CPC H04R 3/14; G10L 19/008; H04R 2400/03; G06F 3/016

(57) ABSTRACT

The present invention provides a vibration and audio output device and electronic equipment. The vibration and audio output device includes a digital audio coding decoder for receiving an external vibration signal and an external audio signal, an audio power amplifier, and a vibration and sounding device. The vibration and sounding device includes a vibration motor, a speaker and a capacitor. The vibration and sounding device is connected with the audio power output end of the amplifier. The vibration and audio output device of the present invention can reduce the use of one power amplifier, which not only reduces the power consumption of the whole device, but also simplifies the complexity of the hardware of the signal transmission path and saves the manufacturing cost.

### FIELD OF THE PRESENT DISCLOSURE

The invention belongs to the technical field of electro-acoustic transducers, and in particular relates to a vibration and audio output device and an electronic equipment using the device.

### DESCRIPTION OF RELATED ART

The vibration and audio output device is a device with a vibration output function and an audio output function, wherein the vibration output function is realized by a vibration motor, and the audio output function is realized by a speaker.

In the existing vibration and audio output device, as shown in FIG. 2, the vibration output device includes a haptic integrated chip (haptic IC) for receiving the vibration signal, and a vibration power amplifier (PA) connected to the haptic integrated chip, and a vibration motor connected to and driven by the vibration power amplifier. The audio output device includes a digital processor that receives audio signals, and an audio power amplifier connected to the digital processor, and a speaker connected to and driven by the audio power amplifier.

However, the existing vibration and audio output device needs to use two different power amplifiers to drive the vibration motor and the speaker respectively. This driving method not only increases the power consumption of the whole device, but also has a high degree of hardware complexity of the signal transmission path, thereby increasing the manufacturing cost.

### SUMMARY OF THE PRESENT INVENTION

One of the purposes of the present invention is to provide a vibration and audio output device with low power consumption, simple signal s transmission path hardware and low production cost.

Accordingly, the present invention provides a vibration and audio output device, including: a digital audio coding decoder for receiving and encoding/decoding external vibration signals and external audio signals, with a first output end thereof used for outputing a vibration signal and a first audio signal; an audio power input end of an amplifier connected to the first output end of the digital audio coding decoder, for outputting the amplified vibration signal and first audio signal respectively; and a vibration and sounding device connecting to the audio power output end of the amplifier. The vibration and sounding device includes a vibration motor for executing the vibration signal amplified by the audio power amplifier to generate vibration, a speaker for executing the first audio signal amplified by the audio power amplifier to generate sound, and a capacitor for dividing frequency of the vibration signal and the first audio signal output after being amplified by the audio power amplifier.

In addition, the vibration motor is connected to the audio power output end of the amplifier; the speaker is connected in series with the vibration motor, and the capacitor is connected in series with the speaker; and wherein the capacitor is connected in parallel with the vibration motor.

In addition, the vibration and audio output device further includes a receiver of the second output end connected to the digital audio coding decoder; the second output end is used for outputting the second audio signal; the receiver receives and executes the second audio signal to produce sound.

In addition, the vibration motor is a biaxial vibration motor.

In addition, the operating frequency range of the vibration motor is f0±30 hz, where f0 is a center frequency of the vibration and sounding device.

The present invention further provides an electronic equipment including a vibration and audio output device as described above.

Compared with the prior art, the vibration and audio output device of the embodiment of the present invention realizes the frequency division of the output signal of the audio power amplifier by adding a capacitor. Therefore, the vibration motor and the speaker can form a two-in-one device, and only one power amplifier is needed to drive the vibration motor and the speaker at the same time. That is, the use of a power amplifier is reduced, which not only reduces the power consumption of the overall device, but also simplifies the complexity of the signal transmission path hardware and saves manufacturing costs.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a frame diagram of a vibration and audio output device provided by an embodiment of the present invention;

FIG. 2 is a frame diagram of a vibration and audio output device related to the present invention.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figures and the embodiment. It should be understood the specific embodiment described hereby is only to explain the disclosure, not intended to limit the disclosure.

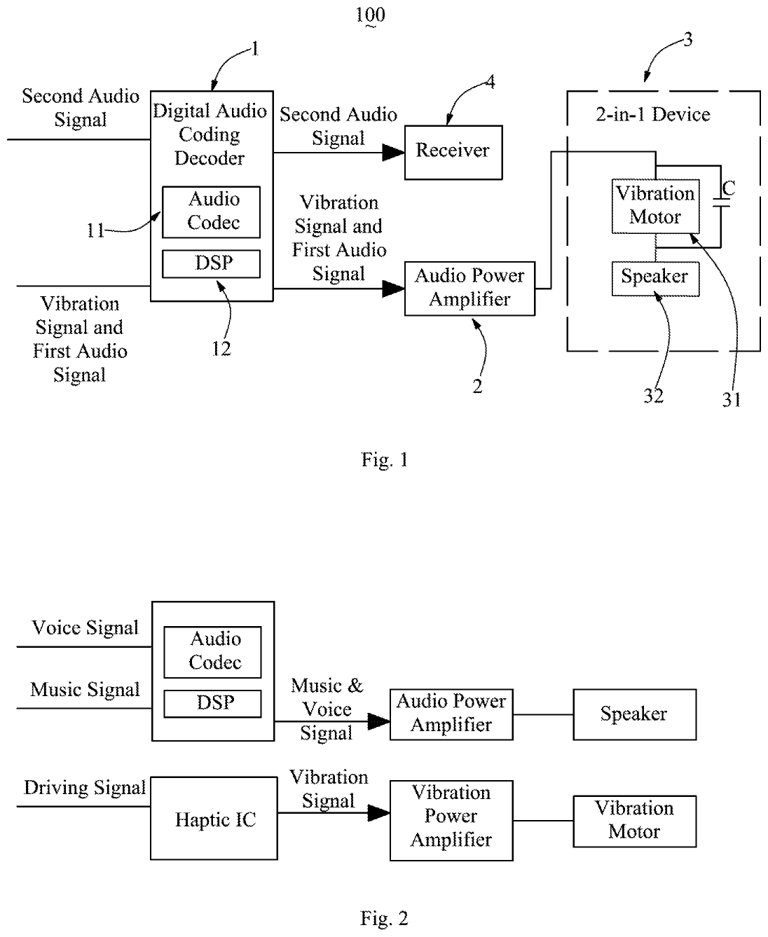

The embodiment of the present invention provides a vibration and audio output device 100, as shown in FIG. 1, which includes a digital audio coding decoder 1, an audio power amplifier 2, and a vibration and sounding device 3.

Specifically, digital audio coding decoder 1 is used to receive and encode/decode external vibration signals and external audio signals. first output end of digital audio coding decoder 1 is used to output vibration signal and first audio signal.

The digital audio coding decoder 1 includes an audio codec unit 11 (Audio Codec) and a digital signal processing unit 12 (DSP).

Specifically, the input end of the audio power amplifier 2 is connected to the first output end of the digital audio coding decoder 1 for respectively amplifying the vibration signal and the first audio signal and then outputting them.

Specifically, the vibration and sounding device 3 includes a vibration motor 31, a speaker 32 and a capacitor c. The vibration and sounding device 3 is connected to the output end of the audio power amplifier 2. The capacitor c divides the frequency of the vibration signal and the first audio signal output after being amplified by the audio power amplifier 2. The vibration motor 31 is used to execute the vibration signal amplified by the audio power amplifier 2 to generate vibration. The speaker 32 is used to execute the first audio signal amplified by the audio power amplifier 2 to generate sound.

In this embodiment, the vibration motor 31 is connected to the output end of the audio power amplifier 2. The speaker 32 is connected in series with the vibration motor 31, and capacitor c is connected in series with speaker 32. The capacitor c and the vibration motor 31 are connected in parallel.

Wherein, the speaker 32 can be connected with the vibration motor 31 through the speaker interface.

In this embodiment, the vibration and audio output device 100 further includes a receiver of the second output end 4 (RCV) connected to the digital audio coding decoder 1. The second output end is used to output the second audio signal, and the receiver 4 receives and executes the second audio signal to make sound.

In this embodiment, the vibration motor 31 is a dual-axis vibration motor 31, which is a motor that can realize vibration in two axis directions (x/y axis directions).

In this embodiment, the operating frequency range of the vibration motor 31 is f0±30 hz, where f0 is the center frequency of the vibration and sounding device 3.

Compared with the prior art, the vibration and audio output device 100 of this embodiment realizes the frequency division of the output signal of the audio power amplifier 2 by adding a capacitor c. The vibration motor 31 and the speaker 32 can form a two-in-one device, and only one power amplifier is needed to drive the vibration motor 31 and the speaker 32 at the same time. That is, the use of a power amplifier is reduced, which not only reduces the power consumption of the overall device, but also simplifies the complexity of the signal transmission path hardware and saves manufacturing costs.

The present invention provides electronic equipment, which includes the vibration and audio output device 100 described above.

In this embodiment, the electronic equipment is a mobile phone. Of course, according to actual needs, the electronic equipment can also be a tablet, a handheld game console, a notebook, and the like.

Since the electronic equipment in this embodiment includes the vibration and audio output device 100, it can also achieve the technical effect achieved by the vibration and audio output device 100 in the embodiment 1, which is not repeated here.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration and audio output device, including:
a digital audio coding decoder for receiving and encoding/decoding external vibration signals and external audio signals, with a first output end thereof used for outputing a vibration signal and a first audio signal;
an audio power input end of an amplifier connected to the first output end of the digital audio coding decoder, for outputting the amplified vibration signal and first audio signal respectively;
a vibration and sounding device connecting to the audio power output end of the amplifier, including a vibration motor for executing the vibration signal amplified by the audio power amplifier to generate vibration, a speaker for executing the first audio signal amplified by the audio power amplifier to generate sound, and a capacitor for dividing frequency of the vibration signal and the first audio signal output after being amplified by the audio power amplifier.

2. The vibration and audio output device as described in claim 1, wherein the vibration motor is connected to the audio power output end of the amplifier; the speaker is connected in series with the vibration motor, and the capacitor is connected in series with the speaker; and wherein the capacitor is connected in parallel with the vibration motor.

3. The vibration and audio output device as described in claim 1, wherein the vibration and audio output device further includes a receiver of the second output end connected to the digital audio coding decoder; the second output end is used for outputting the second audio signal; the receiver receives and executes the second audio signal to produce sound.

4. The vibration and audio output device as described in claim 1, wherein, the vibration motor is a biaxial vibration motor.

5. The vibration and audio output device as described in claim 1, wherein, the operating frequency range of the vibration motor is f0±30 hz, where f0 is a center frequency of the vibration and sounding device.

6. An electronic equipment including a vibration and audio output device as described in claim 1.

7. The electronic equipment as described in claim 6 being a mobile phone.
